(19) United States
(12) Patent Application Publication
(10) Pub. No.: US 2016/0269578 A1
(43) Pub. Date: Sep. 15, 2016

(54) HEAD MOUNTED DISPLAY APPARATUS AND METHOD FOR CONNECTING HEAD MOUNTED DISPLAY APPARATUS TO EXTERNAL DEVICE

(71) Applicants: Tomoyuki Nozawa, Kanagawa (JP); Nekka MATSUURA, Kanagawa (JP)

(72) Inventors: Tomoyuki Nozawa, Kanagawa (JP); Nekka MATSUURA, Kanagawa (JP)

(73) Assignee: RICOH COMPANY, LTD., Tokyo (JP)

(21) Appl. No.: 15/015,416

(22) Filed: Feb. 4, 2016

(30) Foreign Application Priority Data
Mar. 11, 2015 (JP) 2015-048673

(51) Int. Cl. H04N 1/00; G06T 11/60; G02B 27/01

(52) U.S. Cl. CPC H04N 1/00493; G02B 27/0172; G06T 11/60; G02B 2027/014; H04N 2201/0089; H04N 2201/0094

(57) ABSTRACT

A see-through head mounted display apparatus includes: a display including an AR display region and a real view image region, the real view image region allowing a user to see a field of view in a real space through the display; a projection device to project an image of display data toward the AR display region of the display so as to display the image of the display data in the AR display region while being superimposed on the field of view in the real space; processing circuitry to identify at least one external device that is present in the real space and displayed in the real view image region of the display, and acquire communication connection information of the identified external device; and a transmitter to transmit the display data to the external device, when communication is established with the identified external device based on the communication connection information.

### CROSS-REFERENCE TO RELATED APPLICATIONS

This patent application is based on and claims priority pursuant to 35 U.S.C. §119(a) to Japanese Patent Application No. 2015-048673, filed on Mar. 11, 2015, in the Japan Patent Office, the entire disclosure of which is hereby incorporated by reference herein.

### BACKGROUND

1. Technical Field

The present disclosure relates to a head mounted display apparatus and a method for connecting the head mounted display apparatus to an external device.

2. Description of the Related Art

Wearable devices have been developed in recent years, each allowing hands free operation by a user wearing the device. Various products or services using the wearable devices are known. A head mounted display (HMD), which is a display mounted on the user's head for use, is a typical example of the wearable devices. Such HMD is also called smartglasses. The HMD is categorized into two types according to an observation system, which are a see-through type (transmissive type) and a non-see-through type (non-transmissive type). The see-through type HMD allows the user to visually recognize a real view as being overlaid on a displayed image, whereas the non-see-through type HMD blocks an incident light from a real view and allows the user to observe only the displayed image.

In the meantime, various information devices are used in the office. Examples of such information device may include single functionality devices such as printers, facsimile machines, or copying machines as well as multifunction peripherals (MFPs) having multiple functions such as a printer function, a facsimile function and a copier function. Projectors and conference systems are also examples of the information device. Further, a system is known, which includes a plurality of information devices that are connected with each other via a network to operate in cooperation.

With the widespread use of such wearable devices in a variety of applications in the office, there is a need for improving operability of the wearable devices that may operate in cooperation with the information devices.

### SUMMARY

In an aspect of the present invention, a see-through head mounted display apparatus, includes a display, a projection device, processing circuitry, and a transmitter. The display includes an augmented reality (AR) display region and a real view image region, the real view image region allowing a user to see a field of view in a real space through the display. The projection device projects an image of display data toward the AR display region of the display so as to display the image of the display data in the AR display region while being superimposed on the field of view in the real space. The processing circuitry is configured to identify at least one external device that is present in the real space and displayed in the real view image region of the display, and acquire communication connection information of the identified external device. The transmitter transmits the display data to the external device, when communication is established with the identified external device based on the communication connection information.

In another aspect of the present invention, a method is provided for connecting a see-through head mounted display apparatus to an external device, the display apparatus including a display to display a scene including an AR display region in which display data are overlaid on a real view image being viewed through the display apparatus. The method includes projecting display data toward the AR display region, specifying an external device that is present in a region of the real view image, acquiring communication connection information of the specified external device, communicating with the external device based on the communication connection information, and transmitting the display data to the specified external device.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1A is a block diagram illustrating a hardware configuration of a see-through display apparatus (head mounted display apparatus) according to an exemplary embodiment of the present invention;

FIG. 1B is a block diagram illustrating an exemplary software configuration of the display apparatus of FIG. 1A;

FIG. 2A is a block diagram illustrating an exemplary hardware configuration of an image processing apparatus (multifunction peripheral: MFP), which is an example of an external device operated using the display apparatus of FIG. 1;

FIG. 2B is a block diagram illustrating an exemplary software configuration of the image processing apparatus (MFP) of FIG. 2A;

FIG. 3 is an exemplary diagram illustrating an image of an office space to be viewed by a user wearing the display apparatus of FIG. 1, with the real view being displayed with information overlaid thereon;

FIG. 4 is a flowchart illustrating a procedure of processing display data in an AR display region by overlaying display data on an external device in a real space according to an exemplary embodiment of the present invention;

FIG. 5 is a flowchart illustrating a procedure of transmitting display data in an AR display region to an external device in a real space by overlaying the display data on the external device according to an exemplary embodiment of the present invention;

FIG. 6 is a diagram illustrating overlaying a display data region displayed in a real view on a detected external device according to an exemplary embodiment of the present invention;

FIG. 7 is a flowchart illustrating a procedure of transmitting display data to an external device in a real space by overlaying the display data on the external device according to an exemplary embodiment of the present invention;

FIG. 8 is a flowchart illustrating a procedure of transmitting display data to an external device at which a user is gazing according to an exemplary embodiment of the present invention;

FIG. 9 is an exemplary diagram for explaining operation to be performed when a user is gazing at the detected image processing apparatus (MFP) of FIG. 2A;

FIG. 10 is a flowchart illustrating a procedure of overlaying a virtual function list of an external device on a real view image and controlling an operation of the external device according to an exemplary embodiment of the present invention;

FIG. 11 is an exemplary diagram illustrating an image having virtual function lists of detected external devices overlaid on a real view according to an exemplary embodiment of the present invention;

FIG. 12 is an exemplary diagram for explaining selection of a function by a user's line of sight from virtual function lists being overlaid on a real view according to an exemplary embodiment of the present invention;

FIG. 13 is a flowchart illustrating a procedure of controlling an operation of an external device according to a user's action state according to an exemplary embodiment of the present invention; and

FIG. 14 is a flowchart illustrating a procedure of controlling an operation of an external device according to a property of an external device according to an exemplary embodiment of the present invention.

The accompanying drawings are intended to depict example embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits, field programmable gate arrays (FPGAs) computers. These terms in general may be referred to as processors.

Unless specifically stated otherwise, or as is apparent from the discussion, terms such as “processing” or “computing” or “calculating” or “determining” or “displaying”, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

An exemplary embodiment of the present invention will be described hereinafter with reference to drawings.

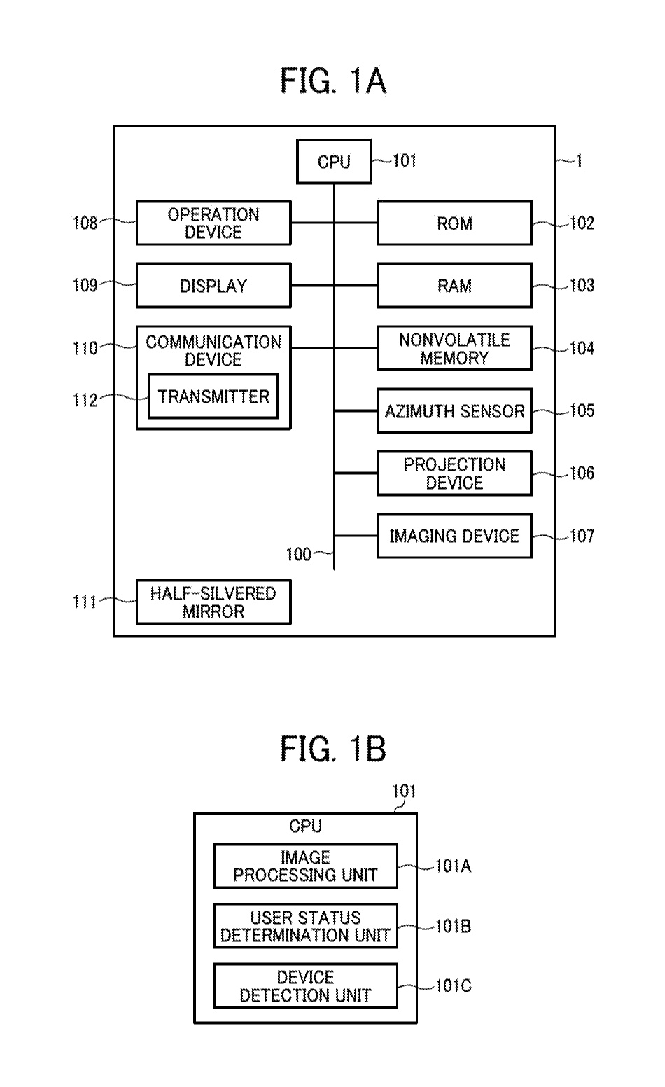

FIGS. 1A and 1B illustrate an exemplary configuration of a see-through head mounted display apparatus 1 (hereinafter referred to as a “display apparatus 1”) according to an exemplary embodiment of the present invention. FIGS. 1A and 1B respectively illustrate the hardware and software configurations of the display apparatus.

The display apparatus 1 includes, as the hardware configuration, a bus 100, a central processing unit (CPU) 101, which is an example of a control device, a read only memory (ROM) 102, a random access memory (RAM) 103, a nonvolatile memory 104, an azimuth sensor 105, a projection device 106, an imaging device 107, an operation device 108, a display 109, and a communication device 110. The devices 102 to 110 are connected to the CPU 101 via the bus 100. The display apparatus 1 further includes a half-silvered mirror 111.

The display apparatus 1 includes, as the software configuration, an image processing unit 101A, a user status determination unit 101B, and a device detection unit 101C, which are processes implemented by the CPU 101 when executing according to a control program stored in the ROM 102.

The CPU 101 controls an operation of the display apparatus 1 according to the program stored in the ROM 102.

The ROM 102 stores various data such as the program and fixed data. The RAM 103 is used as, for example, a work memory that temporarily stores various data when the CPU 101 executes the program. The nonvolatile memory 104 stores various setting information.

The azimuth sensor 105 includes plural geomagnetic sensors and plural acceleration sensors, which may be used in combination. The azimuth sensor 105 detects a posture of a user, who is wearing the display apparatus 1, a direction toward which the user is looking, or an angle of the user's face. The azimuth sensor 105 also detects the direction or speed of movement when the display apparatus 1 is inclined, for example, and notifies the CPU 101 of a result of the detection.

The CPU 101 recognizes the posture or angle of the user, who is wearing the display apparatus 1, or the direction or speed of movement such as the inclination of the display apparatus 1 based on the notification from the azimuth sensor 105.

The projection device 106 projects an image of a projection target toward the half-silvered mirror 111. With this configuration, the user is able to see the image projected by the projection device 106 as being overlaid on the real field of view, as if a semi-transparent display were present in front of the user. The image projected by the projection device 106 is also referred to as “display data” hereinafter.

The imaging device 107 takes an image of a real space in the direction of the user's view, who is wearing the display apparatus 1. In this exemplary embodiment, the imaging device 107 takes an image in the range that is the same as a range of the field of view for the user looking ahead.

Examples of the operation device 108 include keys that allow the user to operate the display apparatus 1. The operation device 108 is used for adjustment of brightness, etc. of the projection image.

The display 109 is a part on which the display data is projected. The half-silvered mirror 111 is disposed in the display 109.

The communication device 110 communicates data with an external device, etc., via a network including a wireless local area network (LAN). Alternatively, the communication device 110 may communicate data directly with the external device by a near-distance wireless communication. The communication device 110 includes a transmitter 112 that transmits the display data projected toward an AR display region (augmented reality space) to an external device that is specified in a real view image area of the user who is wearing the head mounted display.

Referring to FIG. 1B, the image processing unit 101A enlarges, reduces or deforms the projection image based on the display data of the projection target that is projected to the half-silvered mirror 111 of the display 109 from the projection device 106.

The user status determination unit 101B detects and determines a current user action state including the posture of the user's head, the movement of line of sight, and the opening and closing of eyelid, and notifies the CPU 101 of the determined current user action state. The CPU 101 executes an operation program that is suitable to the determined action state of the user in response to the notification from the user status determination unit 101B to control operation of each device according to the determined user action state.

The user status determination unit 101B includes various sensors such as a global positioning system (GPS) sensor, a gyro sensor, a pressure sensor, a myoelectric sensor, and an electrooculography sensor, an internal camera directed to the user's face, or a microphone that collects the user's voice, to acquire the current user action state from the user.

For example, the user status determination unit 101B acquires the user's line of sight (movement of eyeballs) based on information that is output from the myoelectric sensor, the electrooculography sensor, or the internal camera.

The device detection unit 101C acquires the image of the user's field of view taken by the imaging device 107, and analyzes the acquired image of the field of view to specify the external device that is present in the acquired image of the field of view. The device detection unit 101C further acquires device information of the specified external device or detects a position of the specified external device in the image of the field of view of the user. The device information includes at least communication connection information such as Internet protocol (IP) address or machine access control (MAC) address. Further, examples of the device information may include a product name, a manufacturing number, a serial number, a device type such as a multifunction peripheral or printer, and information on a function of the device such as a copier function, a printer function, and a scanner function.

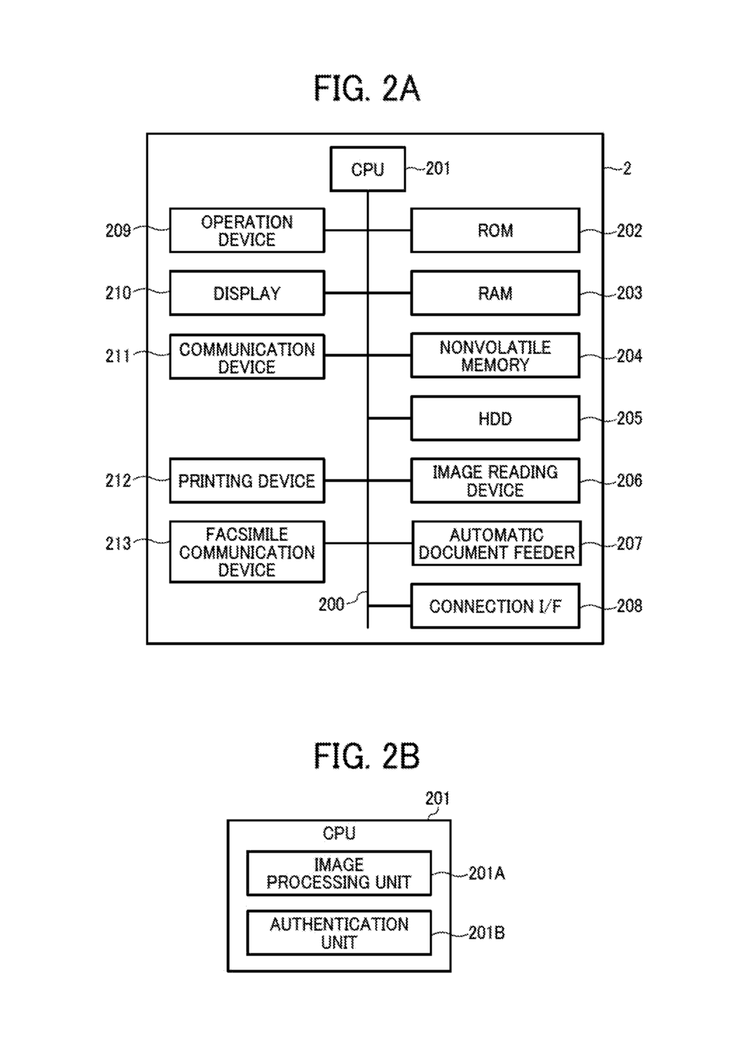

FIGS. 2A and 2B illustrate an exemplary configuration of an image processing apparatus (multifunction peripheral: MFP) 2, which is an example of the external device operated using the display apparatus 1 of FIG. 1. FIGS. 2A and 2B respectively illustrate the hardware and software configurations thereof.

<Hardware Configuration>

The image processing apparatus (MFP) 2 includes a bus 200, a CPU 201, which serves as a control unit, a ROM 202, a RAM 203, a nonvolatile memory 204, a hard disk drive (HDD) 205, an image reading device 206, an automatic document feeder 207, a connection interface (I/F) 208, an operation device 209, a display 210, a communication device 211, a printing device 212, and a facsimile communication device 213. The devices 202 to 213 are connected to the CPU 201 via the bus 200.

The CPU 201 controls an operation of the image processing apparatus (MFP) 2 according to a control program stored in the ROM 202. The ROM 202 stores various data such as the program or fixed data. The RAM 203 is used as, for example, a work memory that temporarily stores various data when the CPU 201 executes the program. The nonvolatile memory 204 stores various setting information.

The hard disk drive 205 is a large-capacity nonvolatile storage, which stores various programs or data as well as print data and image data.

The image reading device 206 optically reads a document to acquire image data. The image reading device 206 includes, for example, a light source, a line imaging sensor, a movement unit, an optical path, and a converter. The light source irradiates the document with light. The line imaging sensor receives the light reflected from the document to read the document one line by one line in a width direction. The movement unit successively moves the reading position in unit of line in a lengthwise direction of the document. The optical path includes a lens and a mirror for guiding the light reflected from the document to the line imaging sensor to form an image. The converter converts an analog image signal that is output from the line imaging sensor to digital image data.

The automatic document feeder 207 feeds the document one by one from the top of a document bundle placed on a document tray to the reading position of the image reading device 206 and ejects the document to a sheet ejection position. The automatic document feeder 207 further has a function of automatically reversing the front and the back of the document to allow the image reading device 206 to automatically read the front and the back of the document.

The connection I/F 208 is a connection port to which an external memory is detachably connected. The imaging processing apparatus 2 may include a plurality of connection I/Fs 208. Examples of the external memory connected to the connection I/F 208 may include a universal serial bus (USB) memory or a SD memory card.

The operation device 209 and the display 210 constitutes a control panel for receiving an operation from the user, such as a job input. The display 210 is configured by, for example, a liquid crystal display. The display 210 has a function of displaying various operation screens, setting screens, etc. The operation device 209 includes various operation keys such as a start key, and a touch panel on a physical screen of the display 210. The touch panel detects a coordinate position touched by a stylus or a finger on the physical screen of the display 210.

The communication device 211 communicates data with an external device, etc., via a network including a wireless local area network (LAN) or directly by a near-distance wireless communication.

The printing device 212 forms an image on a recording paper according to the image data. The printing device 212 includes a transfer unit for transferring the recording paper, a photoconductor drum, a charging unit, a laser unit, a developing device, a transfer separation device, a cleaning device, and a fixing device. The printing device 212 forms an image by electrophotographic process.

The facsimile communication device 21 communicates the image data with an external apparatus having a facsimile function via a telephone line.

<Software Function>

As illustrated in FIG. 2B, the image processing apparatus 2 includes an image processing unit 201A and an authentication unit 201B, which are processes implemented by the CPU 201 when executing according to the program stored in the ROM 202.

The image processing unit 201A enlarges, reduces or rotates the image. Further, the image processing unit 201A performs raster processing for converting printing data to image data. Furthermore, the image processing unit 201A compresses or decompresses the image data.

The authentication unit 201B authenticates a user who uses the image processing apparatus (MFP) 2. Any desired authentication operation may be applied, such as password authentication, fingerprint authentication, vein authentication or integrated circuit (IC) card authentication.

In this exemplary embodiment, explanation has been made of the image processing apparatus (MFP) 2 as an example of the external device that is operated with the display apparatus 1 in FIG. 1. However, various types of information processing apparatus having a single function or multiple functions may be applied as the external device.

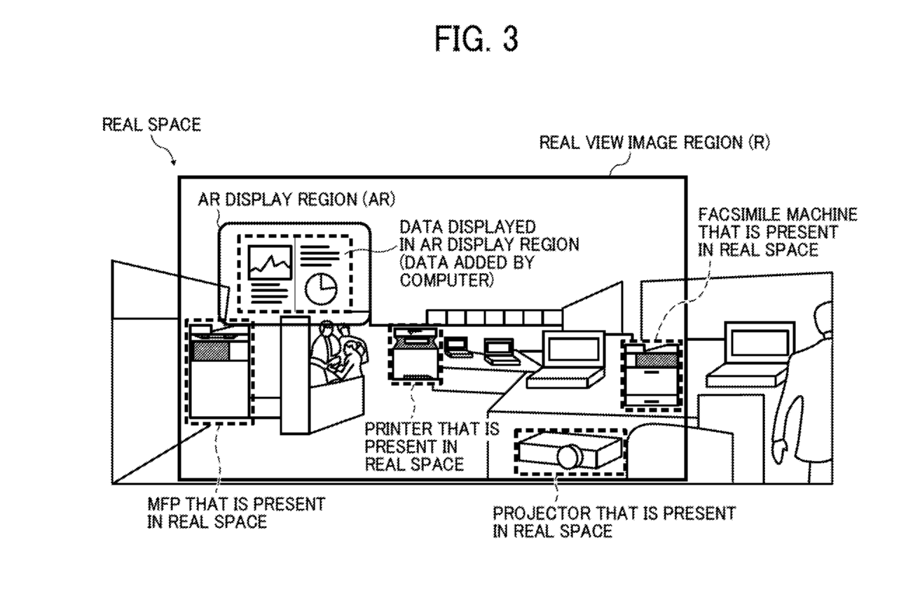

FIG. 3 is an exemplary diagram illustrating an image of an office space (real space) to be viewed by the user wearing the display apparatus 1, with the real view (view image region) being displayed with information (display data) overlaid thereon.

A real view image region (R) illustrated in FIG. 3 is a region in a real space that the user is visually recognizing through the display apparatus 1. The real view image corresponds to the image of the user's field of view. The AR display region is a region for displaying the display data acquired by the display apparatus 1. In the AR display region, data added by a computer is displayed as being superimposed on the real view.

In this exemplary embodiment, the display data may be acquired from the communication device 110 and stored in advance in the display apparatus (HMD) 1. Alternatively, the display data may be stored in advance in a memory such as a hard disk of the display apparatus 1 or in an external memory such as a USB memory or a SD memory card, which is detachably connected to the display apparatus 1.

The real view image region (R), which the user is visually recognizing via the display apparatus 1, overlaps in part with the AR display region (AR). In such overlapping part, the user is able to visually recognize the real space behind the AR display region (AR).

Further, in this exemplary embodiment, in the office space (real space), various external devices, such as a MPF, a printer, a projector or a facsimile machine, are present in the user's field of view, which corresponds to the user's field of view image area (R).

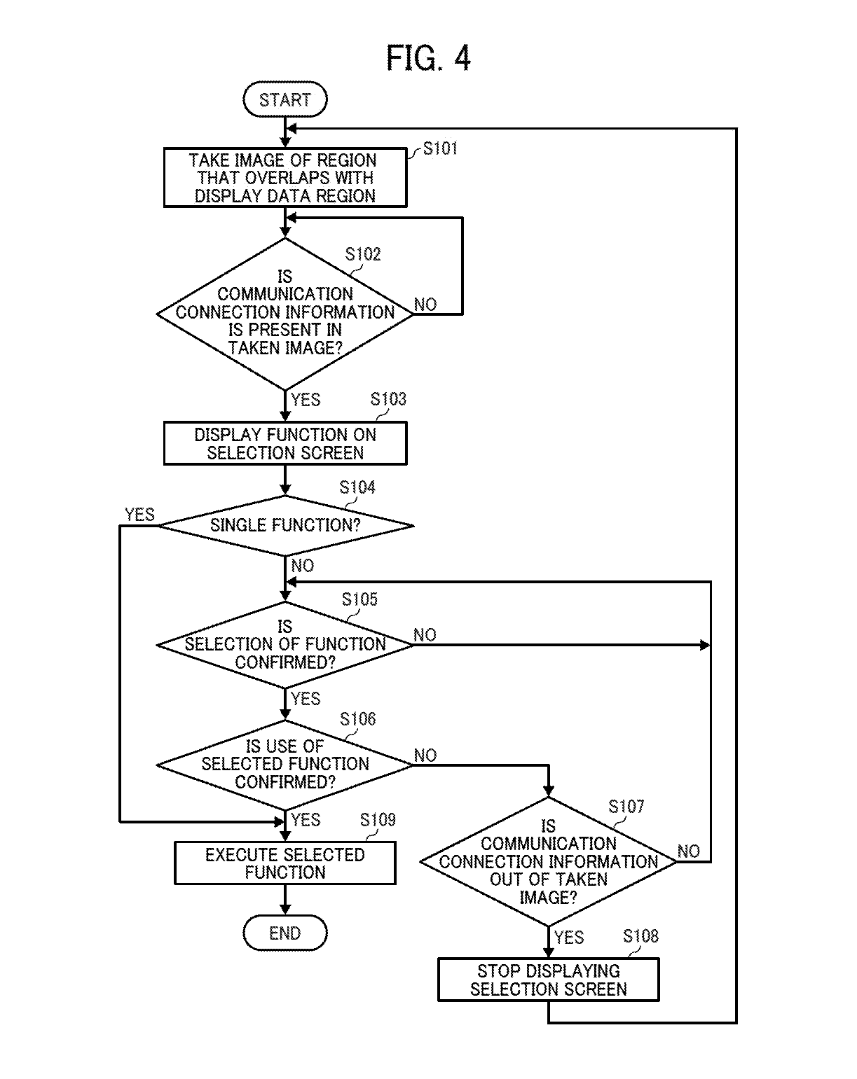

FIG. 4 is a flowchart illustrating a procedure of processing the display data in the AR display region by overlaying the display data on the external device in the real space according to an exemplary embodiment.

With reference to FIG. 4, explanation will be made of the procedure of processing the display data in the AR display region by overlaying the display data on the external device in the real space.

First, the imaging device 107 of the display apparatus 1 takes an image of a region that overlaps with an image displayed on the display apparatus 1 on the user's line of sight (S101). The display apparatus 1 periodically determines whether communication connection information is present in the image taken by the imaging device 107. The communication connection information is the device information that allows the display apparatus 1 to communicate with the external device (S102). Examples of the communication connection information may include a QR code (registered trademark) storing an IP address for accessing the external device. When the communication connection information is present in the image taken by the imaging device 107 (S102: YES), the display apparatus 1 establishes communication with the external device based on the communication connection information to acquire a function that the external device can execute, such as printing, displaying, facsimile transmission, or saving.

At S103, the display apparatus 1 displays the acquired function as a function that the user can select in the AR display region (selection screen) of the display apparatus 1. When the external device is able to execute a single function (S104: YES), the processing proceeds to S109.

When the external device is able to execute plural functions such as printing, displaying, facsimile transmission, or saving (S104: NO), the display apparatus 1 detects the current user action state to determine which function the user selects from among the plural functions (S105).

The user may select the desired function using known techniques that save user's efforts such as an operation of keys. For instance, the user may select the desired function by gazing at a virtual function icon displayed on the display apparatus 1. In other words, the user may select the function by overlaying the user's line of sight on the function icon. Alternatively, the user may select the function by means of gesture input, such as a movement of the user's hand, foot or line of sight, or the opening and closing of eyelid.

In response to the user's selection of the function (S105: YES), the display apparatus 1 confirms whether the user wants to use the selected function (S106). For example, the display apparatus 1 displays a message, “Do you want to print?” When the user selects using “printing” that he/she wants to use by gazing (S106: YES), the display apparatus 1 transmits the display data to the external device to cause the electronic device to execute the selected function (S109).

When the user does not select to use the function (printing) (S106: NO), the processing returns to S105 except when the communication connection information used for the communication between the display apparatus 1 and the external device is outside the image taken by the imaging device (S107: NO), and the display apparatus 1 keeps displaying the selection screen until the user selects to use the function.

When the communication connection information that allows the display apparatus 1 to communicates with the external device is out of the image taken by the imaging device (S107: YES), the display apparatus 1 stops displaying the selection screen (S108). Then, the processing returns to S101 and repeats the subsequent operations.

Thus, the display apparatus 1 confirms that the user intends to use the function. Accordingly, even when the function (e.g. printing) is selected without the user's intention just because the external device happens to into the user's sight, the external device is prevented from executing the function in error.

Hereinafter, explanation will be made of the processing procedure performed by the display apparatus 1 of overlaying the display data in the AR display region on the external device that is present in the real space to transmit the display data to the external device.

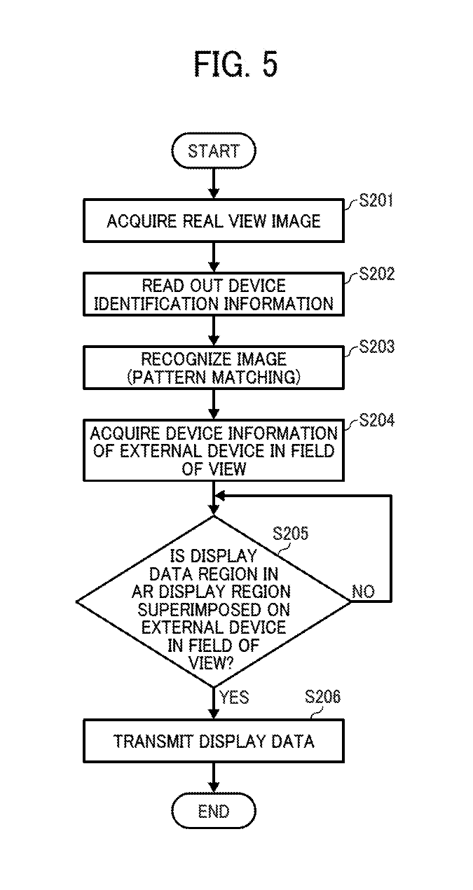

FIG. 5 is a flowchart illustrating a procedure of transmitting the display data in the AR display region to the external device by overlaying the display data on the external device in the real space according to an exemplary embodiment.

The display apparatus 1 acquires or loads the image of the real view taken by the imaging device 107 (S201), and reads out device identification information, which is stored in advance in the display apparatus 1 (S202).

In an exemplary embodiment, the device identification information means information storing a feature of appearance of the device such as the size, shape, color or pattern thereof, or information storing an identifier such as a pattern of a bar code on a surface of the device.

The display 1 specifies a target device as a copier ZYX or a printer ABC based on this device identification information and image information (e.g., a photographed image of the device).

The display apparatus 1, for example, analyzes the real view image taken by the imaging device 107 based on the device identification information by image recognition processing including pattern matching to specify (identify) the external device that is present in the user's field of view (S203). Then, the display apparatus 1 acquires the device information of the specified (identified) external device, including the communication connection information such as the device IP address or a password (S204). In addition, the display apparatus 1 detects a position or region information of the external device in the image of the user's field of view.

The specification (identification) of the external device in the field of view of the user and the detection of the position or the region information of the external device are updated according with the movement of the display apparatus 1. The updated information is stored in the display apparatus 1.

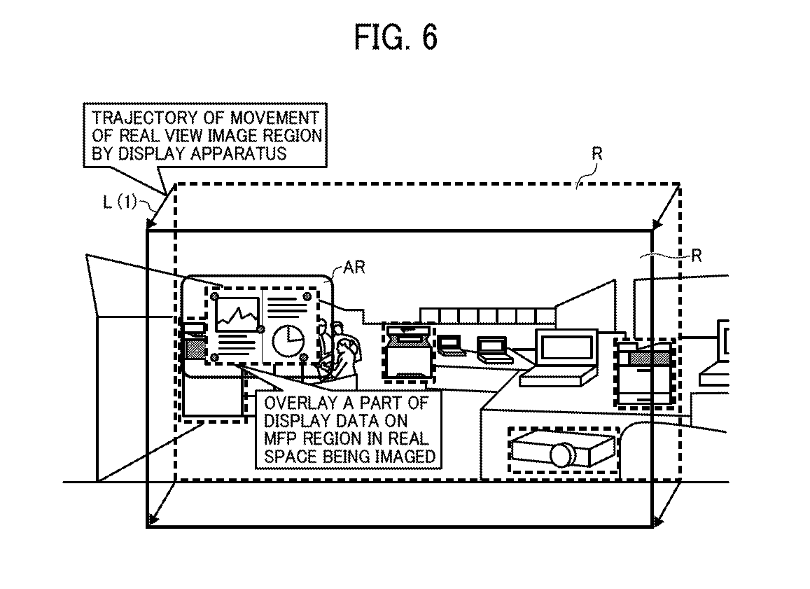

Next, the display apparatus 1 recognizes (or detects) whether the display data in the AR display region (AR) of the display apparatus 1 is superimposed on the region of the detected external device (S205; FIG. 6). In this exemplary embodiment, the display apparatus 1 recognizes (or detects) whether a predetermined point in the AR display region (AR) is superimposed on the region of detected external device. For example, the display apparatus 1 recognizes the superimposition by detecting, for example, that four corners or a center of the virtual data region overlaid on the real view is present in the region of the detected external device.

When the display apparatus 1 recognizes that the display data in the AR display region is superimposed on the region of the external device (S205: YES), the display apparatus 1 establishes the connection between the display apparatus 1 and the external device based on the device information of the specified (identified) external device, and transmits the display data displayed in the AR display region (AR) to the external device (S206). The external device processes the transmitted display data according to the property or attribute of the external device. For example, in a case where the external device is implemented by a projector, the external device displays the display data. Further, in a case where the external device is implemented by a printer, the external device prints the display data. Furthermore, in a case where the external device is implemented by a storage, the external device stores the display data. Alternatively, the external device may process the display data in response to the user's instruction.

FIG. 6 is an exemplary diagram illustrating overlaying the display data region displayed in the real view (the real view image region (R)) on the detected external device, which is the image processing apparatus (MFP) 2 in this example.

In FIG. 6, a line L (1) represents a trajectory of movement of the real view image region (R) by the display apparatus 1. In other words, the real view image moves from the front side of FIG. 6 to an image sectioned by a dotted line on the back side of FIG. 6.

In FIG. 6, a part of dashed line area of the display data is overlaid on the MFP 2 in the real space of which image is captured by the imaging device 107.

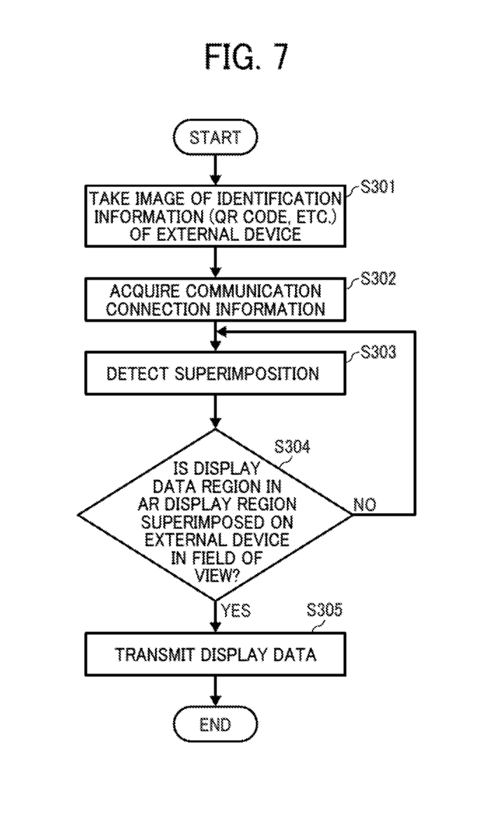

FIG. 7 is a flowchart illustrating a procedure of transmitting the display data to the external device by overlaying the display data on the external device in the real space (real view image region (R)) according to an exemplary embodiment.

In the description so far, explanation has been made of performing the image analysis processing (image recognition by pattern matching) of the real view image taken by the imaging device 107 to acquire the communication connection information that is used for the communication between the display apparatus 1 and the external device. Alternatively, the communication connection information of the external device may be acquired by taking an image of the identification information such as QR code (registered trademark), which is displayed on the external device or stuck to the housing of the external device, in a substantially similar manner as described above.

Specifically, as illustrated in FIG. 7, the imaging device 107 of the display apparatus 1 takes an image of the identification information such as QR code (registered trademark) of the external device (S301). Then, based on the image of the identification information, the display apparatus 1 acquires and specifies the communication connection information of the external device, such as the IP address of the device or the password (S302).

Next, the display apparatus 1 detects whether the display data in the AR display region of the display apparatus 1 is superimposed on the region of the detected external device (S303). Specifically, the display apparatus 1 recognizes the superimposition by, for example, detecting that a predetermined point such as four corners or a center of the virtual data region overlaid in the real view is present in the region of the external device (S304).

When the display apparatus 1 recognizes that the display data in the AR display region (AR) is superimposed on the region of the external device (S304: YES), the display apparatus 1 establishes the connection between the display apparatus 1 and the external device based on the device information of the specified (identified) external device, and transmits the display data displayed in the AR display region (AR) to the external device (S305). The transmitted display data is subjected to various processing by the external device, such as printing, displaying or saving, according to the property of the external device or the user's instruction. After S305, the processing ends.

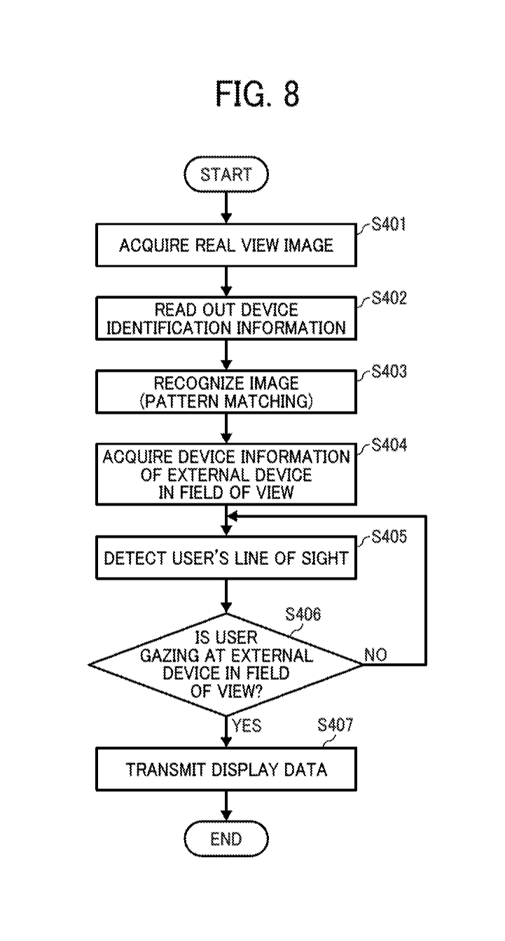

FIG. 8 is a flowchart illustrating a procedure of transmitting the display data to the external device at which the user is gazing according to an exemplary embodiment.

The display apparatus 1 acquires or loads the image of the real view taken by the imaging device 107 (S401), and reads out the device identification information, which is stored in the display apparatus 1 (S402).

The display apparatus 1 analyzes the image of the real view based on the device information by image recognition including pattern matching to specify (identify) the external device that is present in the user's view (S403). Then, the display apparatus 1 acquires the device information of the specified (identified) external device (S404). In addition, the display apparatus 1 detects the region information of the external device in the image of the user's field of view.

The specification (identification) of the external device in the field of view of the user and the detection of the position or the region information of the external device are updated according with the movement of the display apparatus 1. The updated information is stored in the display apparatus 1.

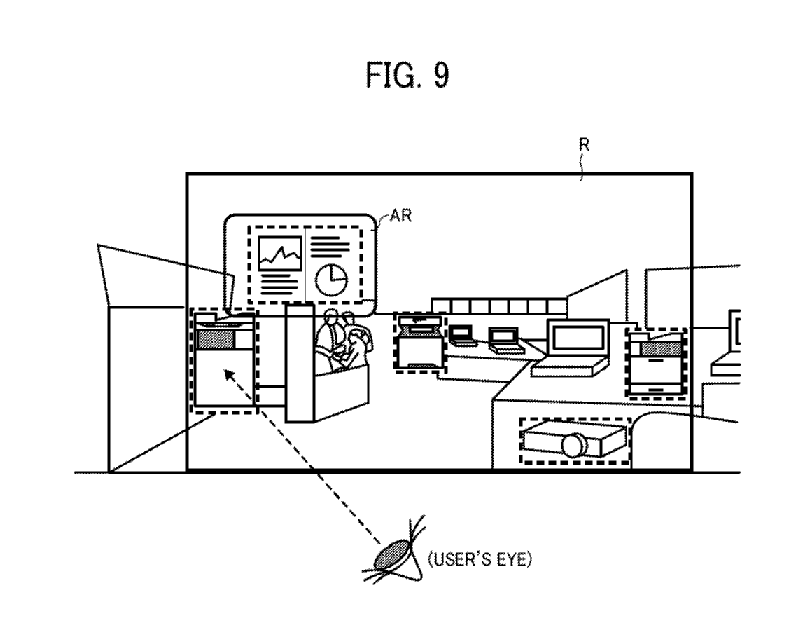

Next, the display apparatus 1 detects the position of the user's line of sight based on the determination on the user's state (S405) to specify a user's target region in the real view image region (R). The real view image corresponds to the image of the user's field of view. In other words, the display apparatus 1 specifies a part of the real view image region with which the user's line of sight crosses as the user's target region. When the detected external device is present in the user's target region for a predetermined time period, the display apparatus 1 determines that the user is gazing at the external device (S406: YES, FIG. 9). Accordingly, the display apparatus 1 establishes the connection between the display apparatus 1 and the external device based on the device information of the specified (identified) external device, and transmits the display data to the external device (S407). The transmitted data is subjected to various processing by the external device, such as printing, displaying or saving, according to the property of the external device or the user's instruction.

When the display apparatus 1 determines that the user is not gazing at the detected external device, the processing returns to the detection of the user's line of sight at S405 to repeat S405 and S406.

FIG. 9 is an exemplary diagram for explaining operation to be performed when the user is gazing at the detected image processing apparatus (MFP).

A dashed line arrow directed from the user's eye represents the user's line of sight, and, in this exemplary embodiment, the image processing apparatus (MFP) is displayed at the destination of the line of sight.

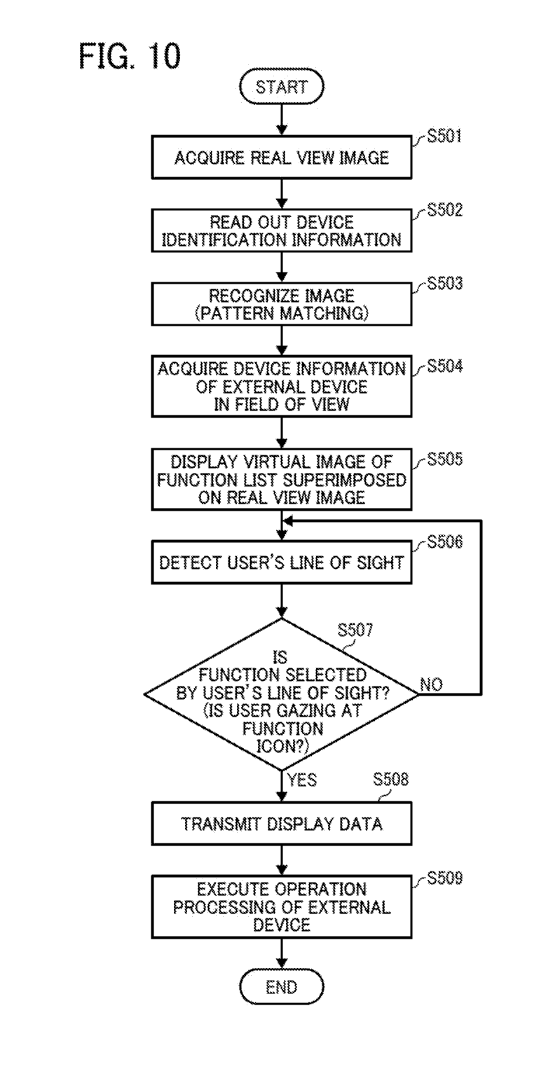

FIG. 10 is a flowchart illustrating a procedure of overlaying a virtual function list of the external device on the real view and controlling an operation of the external device according to an exemplary embodiment.

First, the display apparatus 1 loads or acquires the image of the real view taken by the imaging device 107 (S501). Next, the display apparatus 1 reads out the device identification information, which is stored in the display apparatus 1 (S502).

The display apparatus 1 specifies (identifies) the external device that is present in the user's view by image recognition such as pattern matching based on the image of the real view taken by the imaging device 107 and the device identification information of the external device (S503). Then, the display apparatus 1 acquires the device information of the specified external device (S504). Further, the display apparatus 1 detects a position or region information of the external device in the image of the user's field of view. The specification (identification) of the external device in the field of view and the region information of the position of the external device are updated according with the movement of the display apparatus 1. The updated information is stored in the display apparatus 1.

At S505, the display apparatus 1 overlays a virtual image of a function icon and/or a character indicating a function that the external device can execute on the real view near the target external device based on the acquired device information of the external device. Examples of the function that the external device can execute may include printing, scanning, saving, faxing, or projecting. FIG. 11 is an exemplary diagram illustrating an image having the virtual function lists of the detected external devices overlaid on the real view.

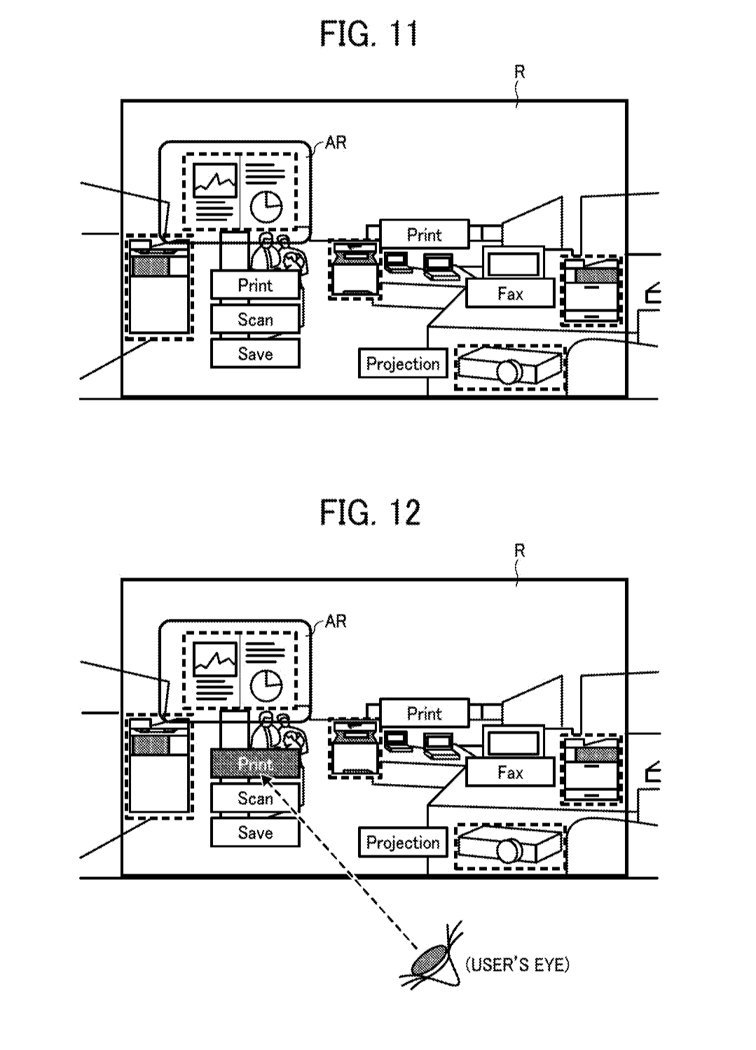

At S506, the position of the user's line of sight is detected by the detection processing of the user's line of sight. Based on the detected position of the user's line of sight, the display apparatus 1 recognizes whether the user is gazing at a certain function icon being displayed (S508). When the display apparatus 1 recognizes that the user is gazing at the function icon (S507: YES), the display apparatus 1 transmits the display data to the external device (S508). In response to the reception of the display data, the external device determines that the function icon is selected and executes the selected function (S509, FIG. 12).

When the display apparatus 1 determines that the user is not gazing at the certain function icon, or, in other words, when the display apparatus 1 determines that the selection is not made by the line of sight (S507: NO), the processing returns to detecting the user's line of sight at S506, to repeat S506 to S509.

FIG. 12 is an exemplary diagram for explaining selection of the function by the user's line of sight from the virtual function lists being overlaid on the real view. In this exemplary embodiment, as illustrated in FIG. 12, the icon of selected function is highlighted so that the user can intuitively recognize the selection.

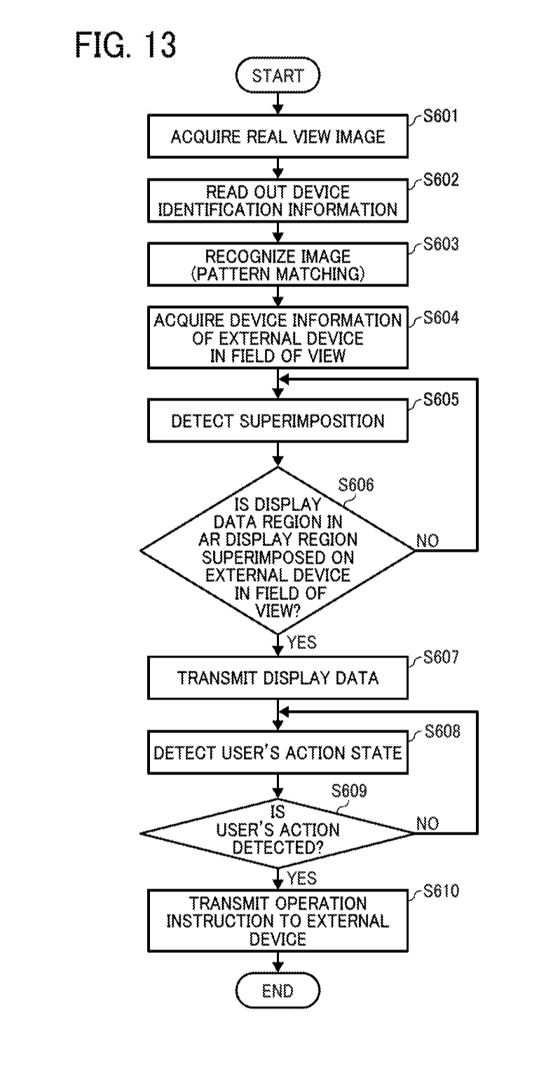

FIG. 13 is a flowchart illustrating a procedure of controlling an operation of the external device according to the current user action state according to an exemplary embodiment.

First, the display apparatus 1 loads or acquires the image of the real view taken by the imaging device 107 (S601), and reads out the device identification information, which is stored in the display apparatus 1 (S602).

The display apparatus 1 analyzes the image of the real view based on the device information by image recognition including pattern matching to specify (identify) the external device that is present in the user's view (5603). Then, the display apparatus 1 acquires the device information of the specified (identified) external device (5604). In addition, the display apparatus 1 detects a position or region information of the external device in the image of the user's field of view. The specification (identification) of the external device in the field of view of the user and the detection of the position or the region information of the external device are updated according with the movement of the display apparatus 1. The updated information is stored in the display apparatus 1.

Next, the display apparatus 1 detects whether the display data in the AR display region of the display apparatus 1 is superimposed on the detected region of the external device (S605). Specifically, the display apparatus 1 recognizes the superimposition by, for example, detecting that a predetermined point such as four corners or a center of the virtual data region is present in the region of the external device. In other words, the display apparatus 1 detects whether four corners or a center of a display region of the display data is present in the region of the external device. When the display apparatus 1 recognizes that the display data in the AR display region (AR) is superimposed on the region of the external device (S606: YES), the display apparatus 1 establishes the connection between the display apparatus 1 and the external device based on the device information of the specified (identified) external device, and transmits the display data displayed in the AR display region (AR) to the external device (S607).

At S608, the display apparatus 1 detects the current user action state. For example, the display apparatus 1 detects the user action state such as the movement of line of sight (movement of eyeballs) or the opening and closing of eyelid as the current user action state based on information that is output from the imaging device 107 that images the user. In this exemplary embodiment, the movement of the user's line of sight is detected as the current user action state; however, such a movement of the line of sight is exemplary. The user's gesture using hand or foot may also be detected as the current user action state. Alternatively, a voice input or information that is input by an operation key or a touch panel on the display apparatus 1 or a remote controller may be detected as the current user action state.

In response to the detection of the current user action state (S609: YES), the display apparatus 1 outputs (transmits) an instruction to the external device for causing the external device to perform an operation corresponding to the current user action state (S610). For example, the display apparatus 1 outputs a printing command in response to the user's wink.

When the display apparatus 1 determines that the current user action state is not detected (S609: YES), the processing returns to the detection of the current user action state at S608 to repeat S608 to S610.

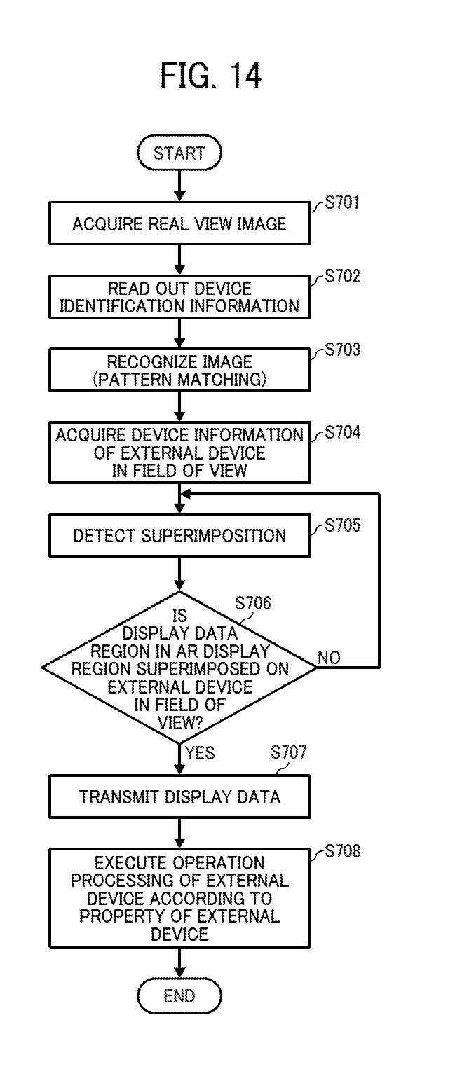

FIG. 14 is a flowchart illustrating a procedure of controlling an operation of the external device according to the property of the external device according to an exemplary embodiment. With the procedure as illustrated in FIG. 14, in a case where the external device is implemented by, for example, a projector, the external device displays the display data. Further, in a case where the external device is implemented, for example, by a printer, the external device prints the display data. Furthermore, in a case where the external device is implemented by, for example, a storage, the external device stores the display data. With such procedure, the operation of the external device is controlled appropriately according to the property of the external device.

First, the display apparatus 1 loads the image of the real view taken by the imaging device 107 (S701), and reads out the device identification information, which is stored in the display apparatus 1 (S702).

The display apparatus 1 analyzes the image of the real view based on the device information by image recognition including pattern matching to specify (identify) the external device that is present in the user's view (S703). Then, the display apparatus 1 acquires the device information of the specified (identified) external device (S704). In addition, the display apparatus 1 detects a position or region information of the external device in the image of the user's field of view.

The specification (identification) of the external device in the field of view of the user and the detection of the position or the region information of the external device are updated according with the movement of the display apparatus 1. The updated information is stored in the display apparatus 1.

Next, the display apparatus 1 detects whether the display data in the AR display region of the display apparatus 1 is superimposed on the detected region of the external device (S705). For example, the display apparatus 1 recognizes the superimposition by detecting that the predetermined point such as four corners or a center of the virtual data region overlaid on the real view is present in the region of the external device. When the display apparatus 1 recognizes that the display data in the AR display region (AR) is superimposed on the region of the external device (S706: YES), the display apparatus 1 establishes the connection between the display apparatus 1 and the external device based on the device information of the specified (identified) external device, and transmits the display data displayed in the AR display region (AR) to the external device (S707). The transmitted data is subjected to various processing by the external device, such as printing, displaying or saving, according to the property of the external device or the user's instruction.

Subsequently, the display apparatus 1 transmits a command to the external device for causing the external device to execute processing according to the property of the external device. For example, in a case where the external device that is a target of control is a projector, the display apparatus 1 outputs a command to the external device for causing the external device to project the transmitted display data on a screen. Further, for example, in a case where the external device that is a target of control is a facsimile machine, the display apparatus 1 outputs a command to the external device for causing the external device to fax an image of the display data. Furthermore, for example, in a case where the external device that is a target of control is a printer, the display apparatus 1 outputs a command to the external device for causing the external device to print out the display data. Thus, the external device executes an operation according to the property of the external device (S705), and the processing ends.

As described so far in detail, the display apparatus 1 according to an exemplary embodiment is able to communicate data with the external device with a simple operation such as superimposing the data displayed on the display apparatus 1 on the external device that is present in the real space. Accordingly, the data transmission and reception are executed between the display apparatus 1 and the external device according to the user's intention or state. Further, the display, printing or saving of the data is also performed according to the user's intention or state. With such configuration, the user is able to control the external device to execute an appropriate action according to the user's intention or state. Accordingly, the user's intuitive operation is enhanced, saving user's efforts such as an operation of keys.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC) and conventional circuit components arranged to perform the recited functions.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

What is claimed is:

1. A see-through head mounted display apparatus, comprising:
a display including an augmented reality (AR) display region and a real view image region, the real view image region allowing a user to see a field of view in a real space through the display;
a projection device to project an image of display data toward the AR display region of the display so as to display the image of the display data in the AR display region while being superimposed on the field of view in the real space;
processing circuitry configured to identify at least one external device that is present in the real space and displayed in the real view image region of the display, and acquire communication connection information of the identified external device; and
a transmitter to transmit the display data to the external device, when communication is established with the identified external device based on the communication connection information.

2. The head mounted display apparatus according to claim 1, wherein the processing circuitry identifies the at least one external device when the display data in the AR display region is superimposed on the at least one external device that is displayed in the real view image region.

3. The head mounted display apparatus according to claim 1, wherein the processing circuitry identifies the at least one external device when the at least one external apparatus is being gazed at by the user through the display.

4. The head mounted display apparatus according to claim 1, wherein the display displays, in the AR display region, a function image representing function information of the identified external device, the function image being at least one of a character and an icon.

5. The head mounted display apparatus according to claim 1, wherein the processing circuitry is configured to determine a current user action state and control an operation of the identified external device based on the determined current user action state.

6. The head mounted display apparatus according to claim 1, wherein the processing circuitry is configured to control an operation of the identified external device according to a property of the identified external device.

7. A method for connecting a see-through head mounted display apparatus to an external device, the display apparatus including a display including an augmented reality (AR) display region and a real view image region, the real view image region allowing a user to see a field of view in a real space through the display, the method comprising:
projecting an image of display data toward the AR display region of the display so as to display the image of the display data in the AR display region while being superimposed on the field of view in the real space;
identifying at least one external device that is present in the real space and displayed in the real view image region of the display;
acquiring communication connection information of the identified external device; and
transmitting the display data to the external device, when communication is established with the identified external device based on the communication connection information.

8. The method according claim 7, wherein the identifying includes identifying the at least one external device when the display data in the AR display region is superimposed on the at least one external device that is displayed in the real view image region.

9. The method according to claim 7, wherein the identifying includes identifying the at least one external device when the at least one external apparatus is being gazed at by the user through the display.

10. The method according to claim 7, further comprising displaying, in the AR display region, a function image representing function information of the identified external device, the function image being at least one of a character and an icon.

11. The method according to claim 7, further comprising:
determining a current user action state; and
controlling an operation of the identified external device based on the determined current user action state.

12. The method according to claim 7, further comprising controlling an operation of the identified external device according to a property of the identified external device.
